(19) United States
(12) Patent Application Publication
(10) Pub. No.: US 2013/0187352 A1
(43) Pub. Date: Jul. 25, 2013

(54) DOLLY

(71) Applicant: Rehrig Pacific Company, Los Angeles, CA (US)

(72) Inventors: Jon P. Hassell, Atlanta, GA (US); Philip King, Sugar Hill, GA (US)

(73) Assignee: REHRIG PACIFIC COMPANY, Los Angeles, CA (US)

(21) Appl. No.: 13/738,119

(22) Filed: Jan. 10, 2013

Related U.S. Application Data
(60) Provisional application No. 61/585,123, filed on Jan. 10, 2012.
(60) Provisional application No. 61/615,423, filed on Mar. 26, 2012.

(51) Int. Cl. B62B 5/00

(52) U.S. Cl. CPC B62B 5/0093
USPC 280/79.11

(57) ABSTRACT

A dolly includes a base having a pair of spaced apart side walls and an end wall connecting the side walls. Casters supporting the side walls and end wall. In one embodiment, a spreader bar assembly is pivotably connected to the dolly to permit a user to selectively connect the dolly to another dolly, such that a pallet could be supported at each end by one of the dollies.

### BACKGROUND

One type of pallet, typically used for delivery of beverage containers to stores, includes a relatively long and narrow deck. A plurality of supports (such as six) extend downward from the deck. The supports are spaced inward from the side edges and end edges of the deck. The pallet can be handled and delivered on a pallet lift jack or fork lift.

### SUMMARY

Several embodiments of dollies for use with a pallet are disclosed. The dollies are particularly adapted for the aforementioned pallet, but the invention is not limited to use with such pallets.

In one embodiment, the dolly includes a longitudinally-elongated base and a divider extending longitudinally along at least a portion of the base. A plurality of casters support the base. A pallet having a deck and a plurality of supports extending downward from the deck the supports spaced inward from peripheral edges of the deck, wherein the plurality of supports are supported on the base of the dolly and wherein the divider is received between the plurality of supports.

In several embodiments, a dolly includes a base having a pair of spaced apart side walls and an end wall connecting the side walls. Casters supporting the side walls and end wall. In one embodiment, a spreader bar assembly is pivotably connected to the dolly to permit a user to selectively connect the dolly to another dolly, such that a pallet could be supported at each end by one of the dollies.

### BRIEF DESCRIPTION OF THE DRAWINGS

Figure is a perspective view of a dolly according to a first embodiment.

FIG. 2 is a top view of the dolly of FIG. 1.

FIG. 3 is a side view of the dolly of FIG. 1.

FIG. 4 is a first end view of the dolly of FIG. 1.

FIG. 5 is a second end view of the dolly of FIG. 1.

FIG. 6 shows a pallet supported on the dolly of FIG. 1.

FIG. 7 is a top view of the pallet and dolly of FIG. 6.

FIG. 8 is a side view of the pallet and dolly of FIG. 6.

FIG. 9 is a first end view of the pallet and dolly of FIG. 6.

FIG. 10 is a second end view of the pallet and dolly of FIG. 6.

FIG. 11 is a perspective view of two dollies according to a second embodiment of the present invention.

FIG. 12 is a top view of the pair of dollies of FIG. 11.

FIGS. 13 and 14 are side and end views, respectively, of the dollies of FIG. 11.

FIG. 15 shows a pallet supported on the pair of dollies of FIG. 11.

FIG. 16 is a side view of the pallet and dollies of FIG. 15.

FIG. 17 is a top view of the pallet and dollies of FIG. 15.

FIG. 18 is an end view of the pallet and dollies of FIG. 15.

FIG. 19 is a perspective view of a dolly according to a third embodiment.

FIG. 20 is an inner perspective view of the dolly of FIG. 19.

FIG. 21 shows the dolly of FIG. 19 with an optional handle mounted thereto.

FIG. 22 shows two of the dollies of FIG. 19 arranged to receive a pallet.

FIG. 23 shows the pallet supported on the pair of dollies.

FIG. 24 is a perspective view of a dolly assembly according to a third embodiment.

FIG. 25 shows the dolly assembly of FIG. 24 in the disconnected, stored position.

FIG. 26 is a rear perspective view of the dolly assembly of FIG. 25.

FIG. 27 is a side view of one of the dollies of FIG. 24.

FIG. 28 is an enlarged interior perspective view of one of the dollies of FIG. 24, as connected to one of the spreader bar assemblies.

### DETAILED DESCRIPTION OF A PREFERRED EMBODIMENT

A dolly 10 according to a first embodiment is shown in FIGS. 1-10. Referring to FIG. 1, the dolly 10 includes a base 12 and casters 14 (swiveling or non-swiveling or two of each). A divider 16 extends lengthwise across the base 12.

The base 12 includes a pair of L-brackets 18 connected to end members 20, 22. The first end member 20 includes a stop plate 26 extending completely or substantially completely across the entire end of the dolly 10. The second end member 22 includes a support plate 24, which is narrow, e.g. just wide enough to form part of the divider 16. In this example, the divider 16 includes a pair of spaced apart rails 28, which could be tubes or rods. The rails 28 extend from the support plate 24 to the stop plate 26.

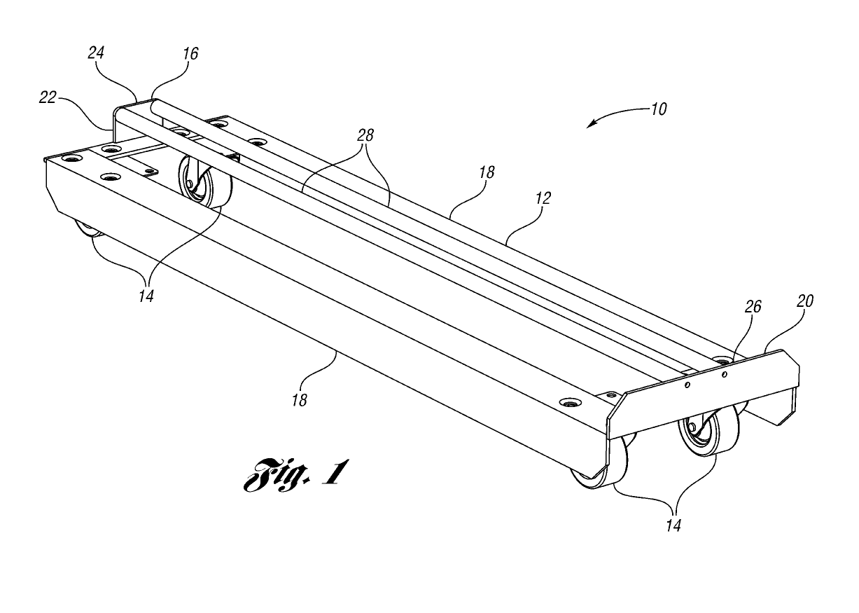

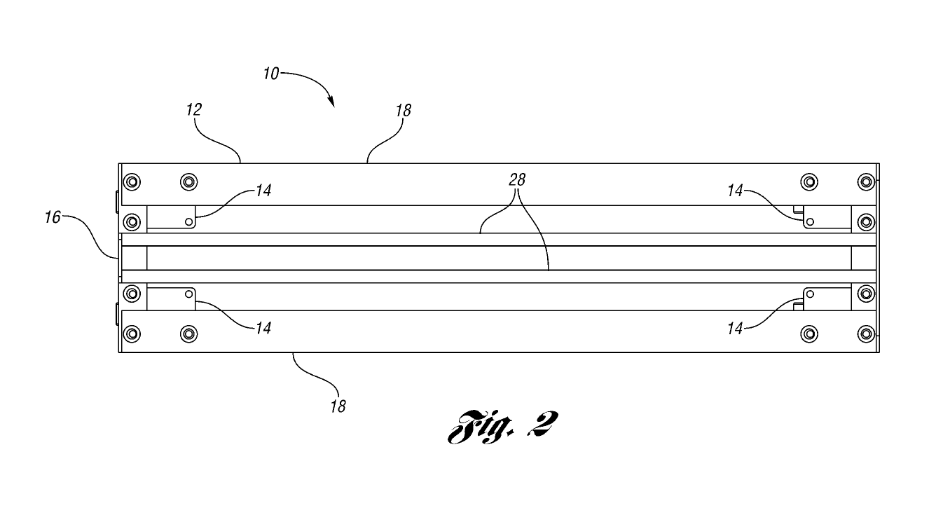

FIG. 2 is a top view of the dolly 10. As shown, the divider 16 is spaced between the L-brackets 18 of the base 12; however, a solid base 12 could also be used.

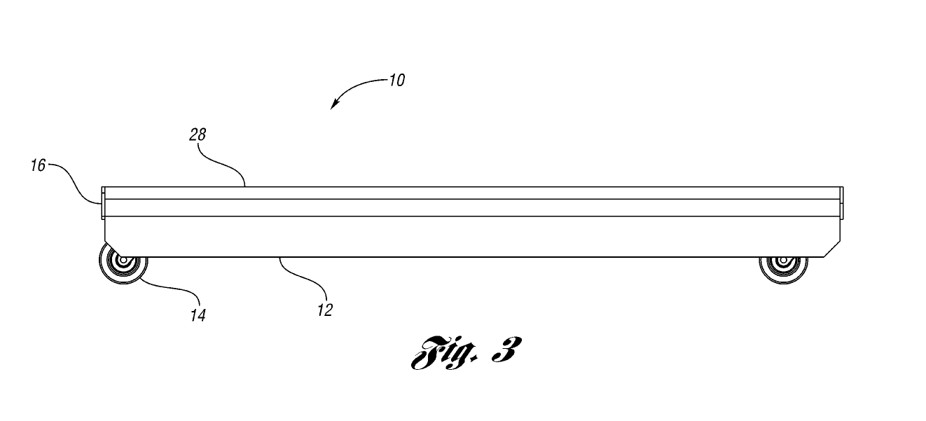

FIG. 3 is a side view of the dolly 10. As shown, the rails 28 of the divider 16 are spaced above the base 12 in this example; however, optionally, a divider could extend upward from a solid base.

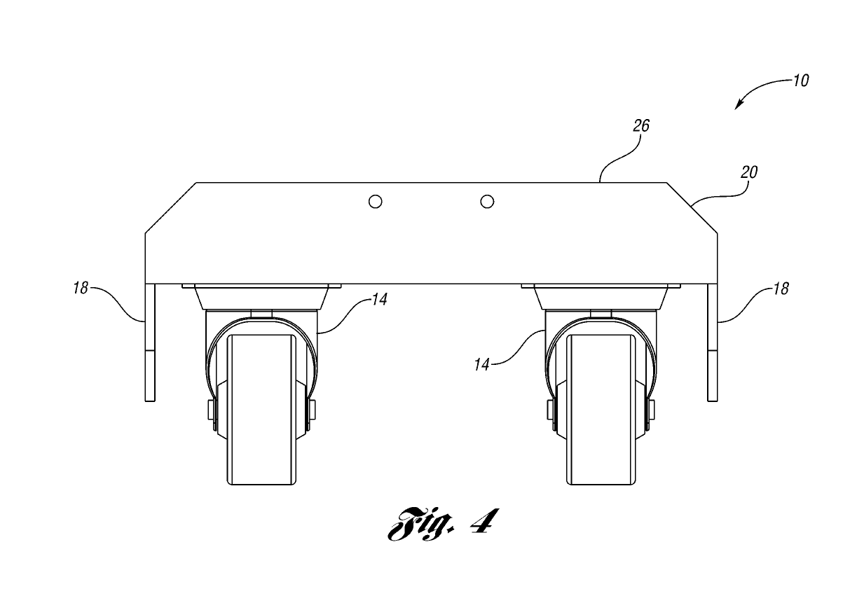

FIG. 4 is a first end view of the dolly 10, showing the stop plate 26 extending completely across the end of the dolly 10. Optionally, the stop plate 26 could be smaller or could be multiple, separate stop plates.

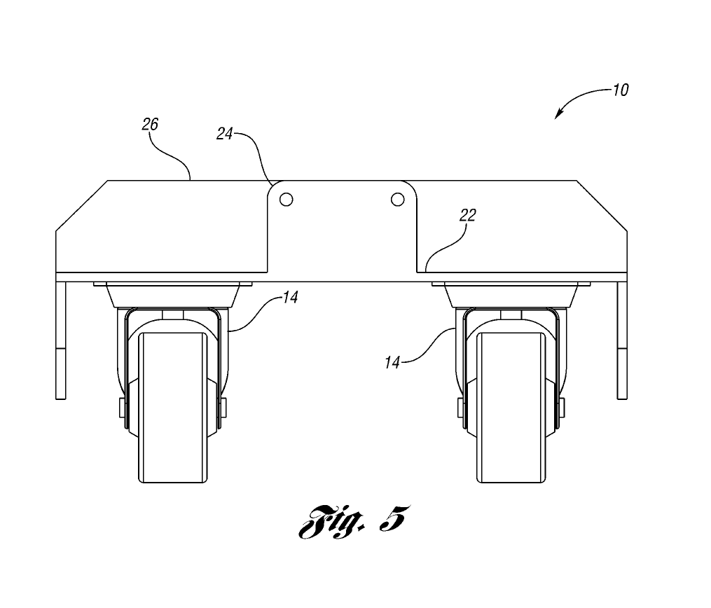

FIG. 5 is a second end view of the dolly 10, showing the support plate 24 on the second end of the dolly 10. The support plate 24 is just wide enough to support the rails 28 (FIG. 1).

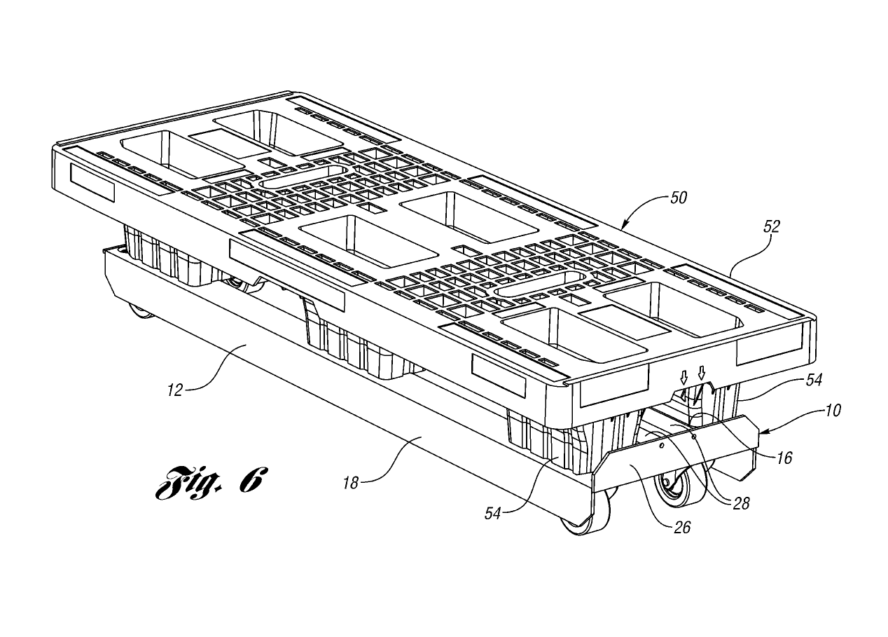

FIG. 6 shows a pallet 50 supported on the dolly 10. The pallet 50 is relatively long and narrow, having a pallet deck 52 with a length more than twice its width. The pallet feet or supports 54 extend downward from the pallet deck 52. The supports 54 are spaced away from the side edges of the pallet deck 52 and spaced away from the end edges of the pallet deck 52. When the pallet 50 is placed on the dolly 10, the pallet supports 54 are supported on the base 12, particularly on the L-brackets 18. The divider 16, in particular the rails 28, extend between the supports 54 for increased stability. The stop plate 26 assists in positioning the pallet 50 on the dolly 10 when the pallet 50 is loaded onto the dolly 10 from the opposite end (the second end) of the dolly 10. The support plate 24 is narrow enough to pass between the supports 54 as the pallet 50 is moved onto the dolly 10.

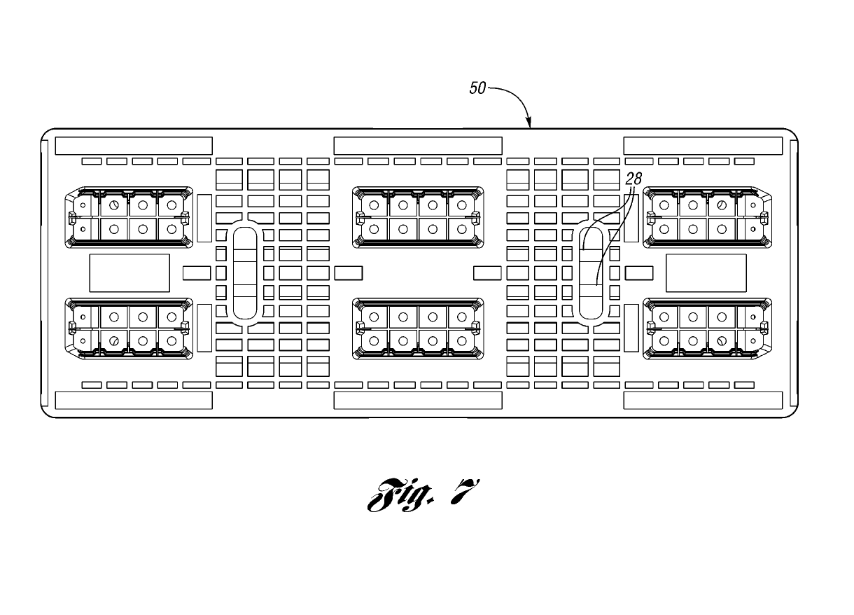

FIG. 7 is a top view of the pallet 50 on the dolly 10. The rails 28 are visible through a handle opening in the deck 52 of the pallet 50.

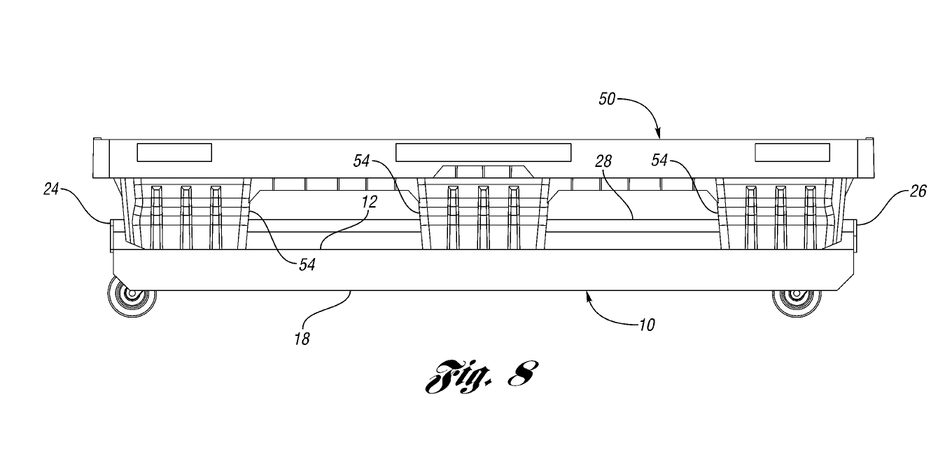

FIG. 8 is a side view of the pallet 50 on the dolly 10. The rails 28 forming the divider 16 are visible between the pallet supports 54.

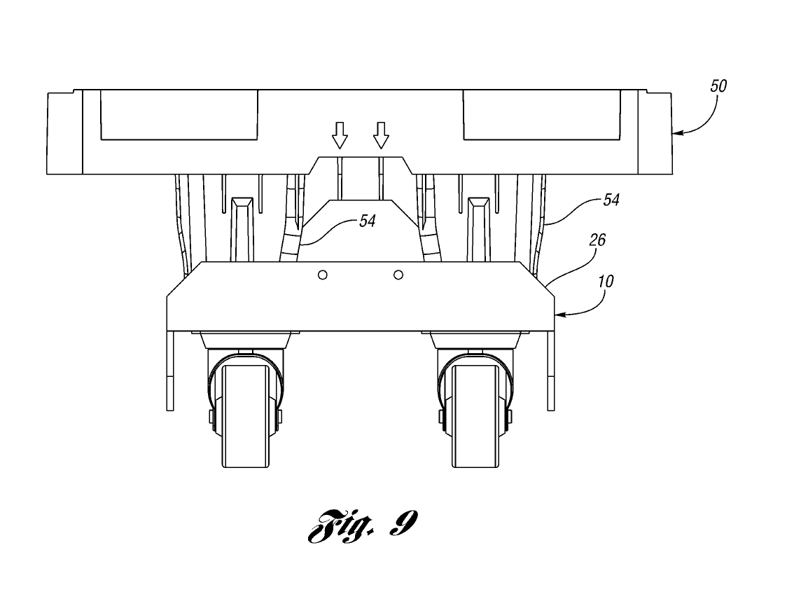

FIG. 9 is a first end view of the pallet 50 on the dolly 10. The pallet supports 54 may abut the stop plate 26.

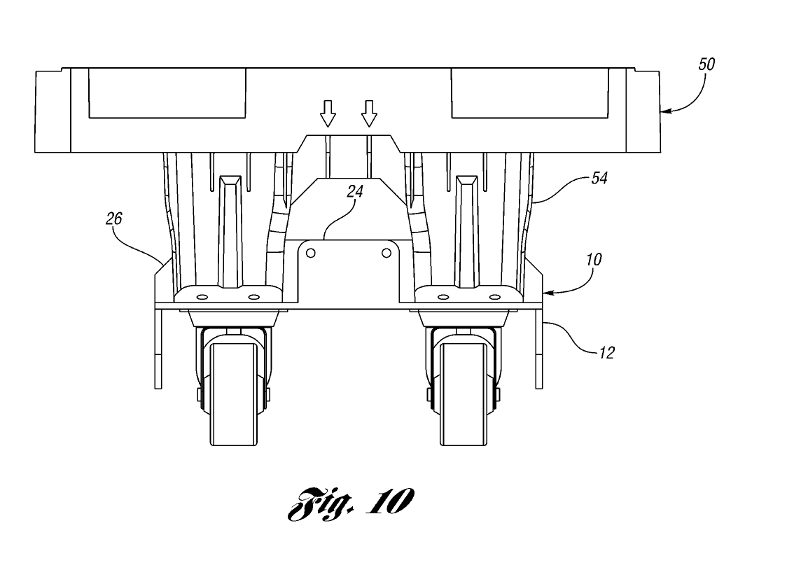

FIG. 10 is a second end view of the pallet 50 on the dolly 10. The support plate 24 is narrow enough to pass between the pallet supports 54.

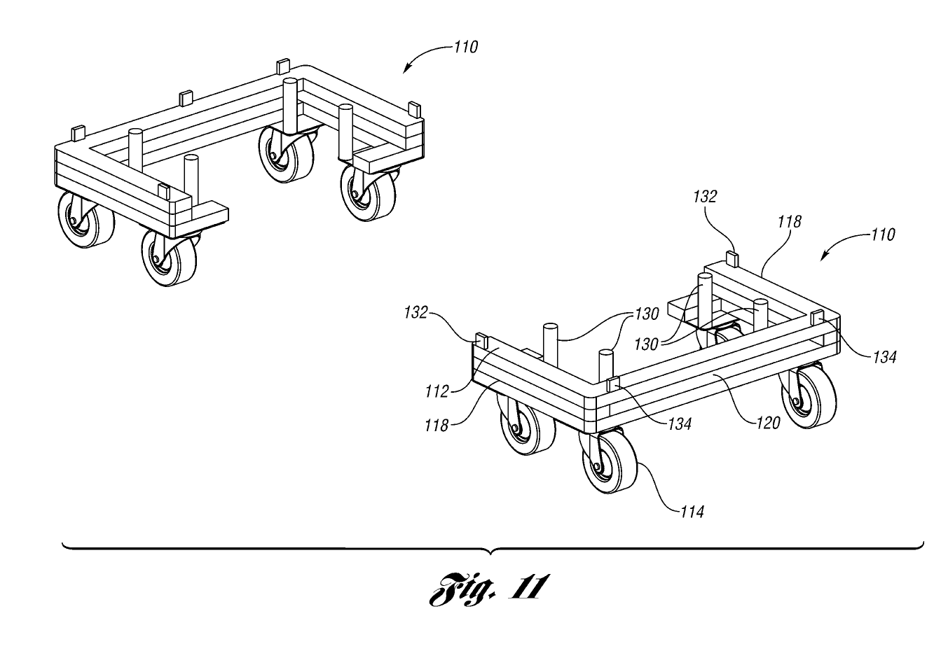

FIG. 11 is a perspective view of two dollies 110 according to a second embodiment of the present invention. In the example shown, the dollies 110 would be used in pairs, each at one end of the pallet. The dolly 110 includes a base 112 having casters 114 supporting the base 112. The base 112 includes a pair of side walls 118 extending upward from the casters 114 and an end wall 120 extending upward from the casters 114 and connecting one end of each of the side walls 118. A post 130 extends upward from an inner corner of each of the mounting plates of the casters 114. The posts 130 in this example are taller than the side walls 118 and end wall 120 and are spaced from the side walls 118 and end wall 120. A side locating tab 132 extends upward from an outer edge of one end of each of the side walls 118. An end locating tab 134 extends upward from an outer edge near each end of the end wall 120.

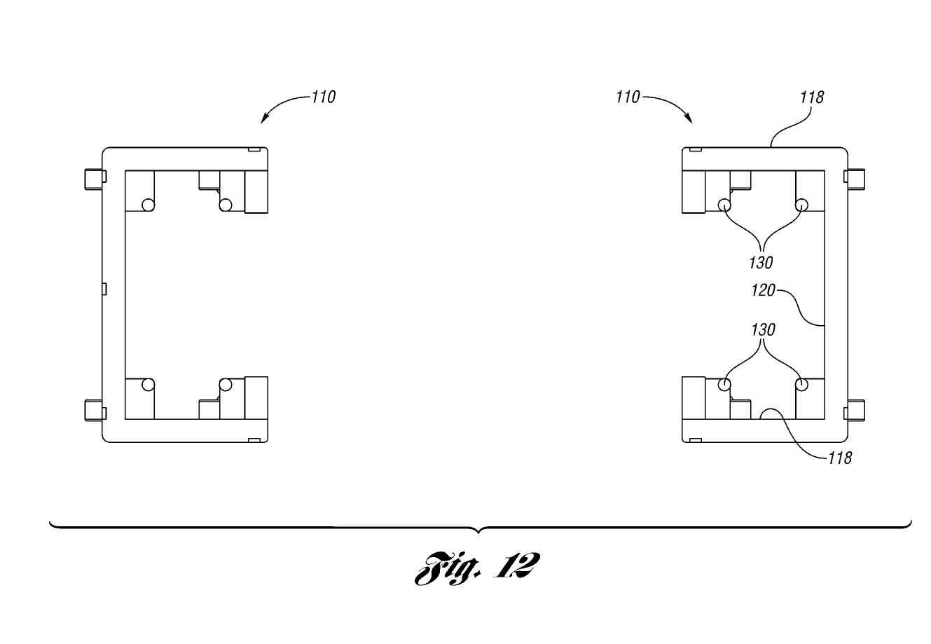

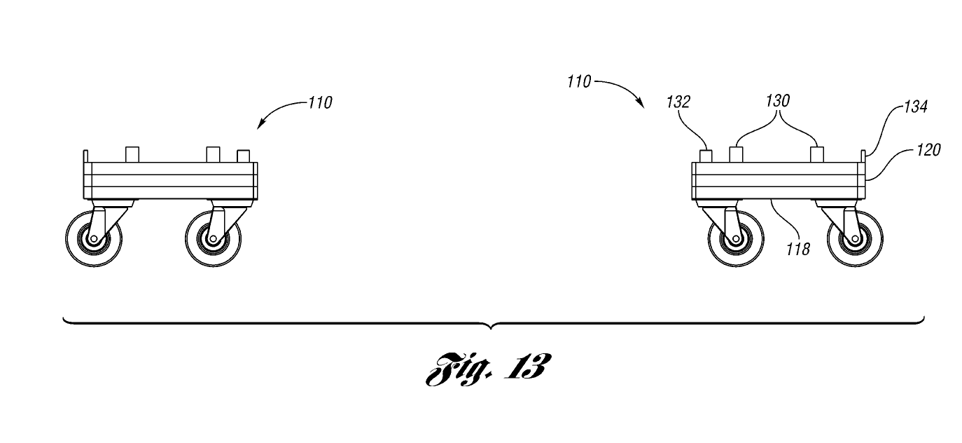

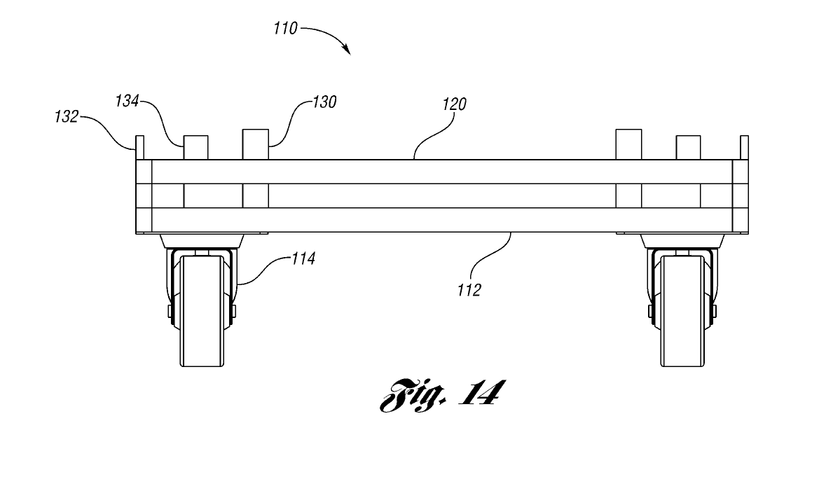

FIG. 12 is a top view of the pair of dollies 110 of FIG. 11. FIGS. 13 and 14 are side and end views, respectively, of the dollies 110. As shown, the posts 130 in this example are taller than the tabs 132, 134, but other height arrangements are possible.

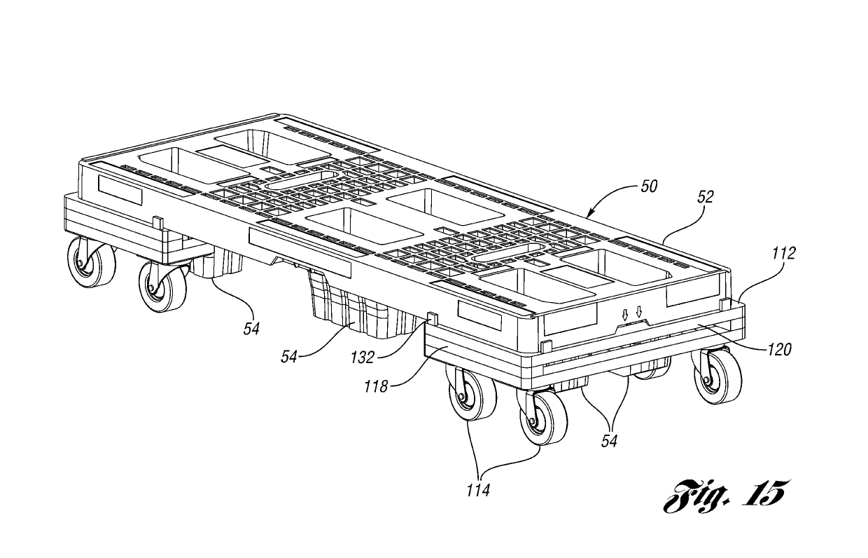

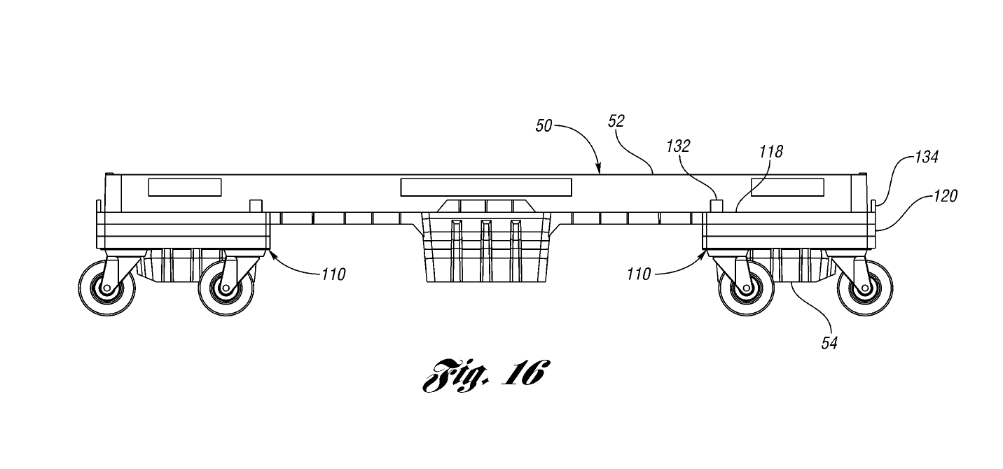

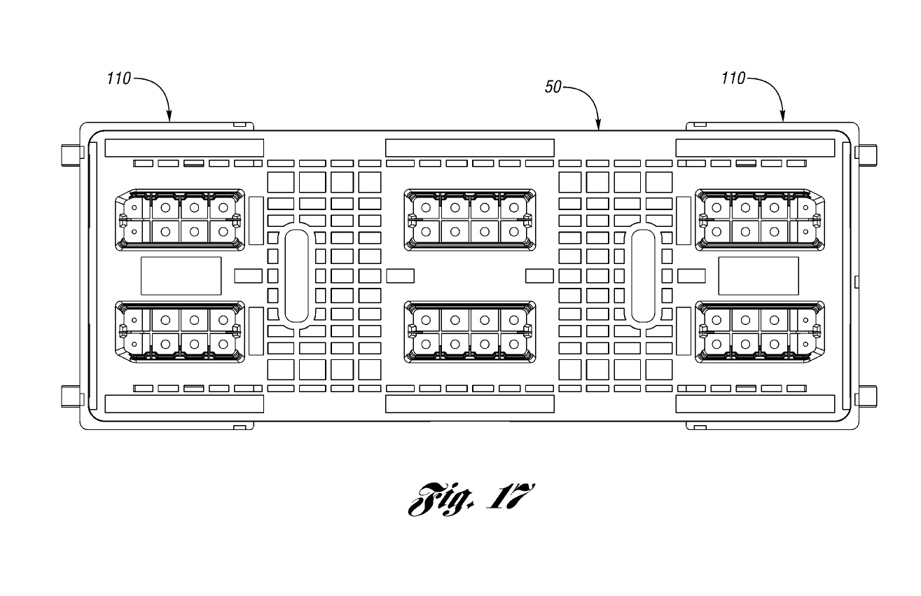

FIG. 15 shows the pallet 50 supported on the pair of dollies 110. The deck 52 of the pallet 50 is supported on the side walls 118 and end wall 120 of each dolly 110. The deck 52 is located between the side tabs 132 and end tabs 134. As shown in FIG. 16, the supports 54 extend downward below the upper surfaces of the side walls 118 and end walls 120. As shown in the top view of FIG. 17, the dollies 110 only slightly increase the footprint of the pallet 50.

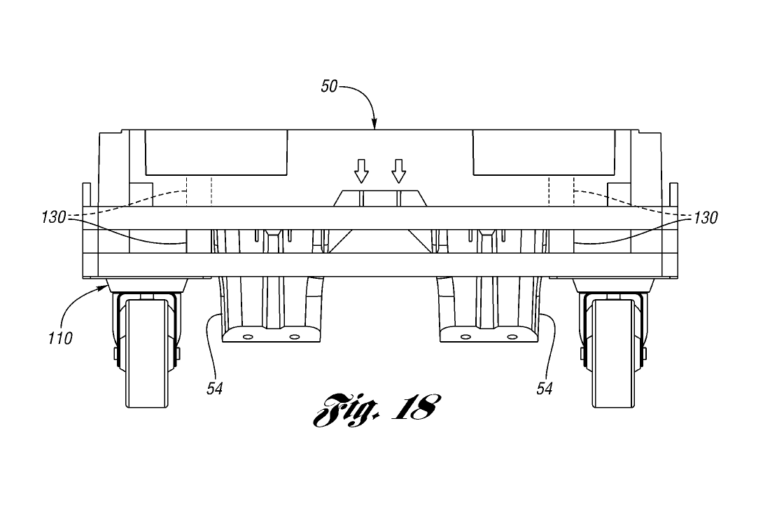

As shown in the end view of FIG. 18, the posts 130 are positioned adjacent the outer edge of the supports 54 for stability. The posts 130 extend upward into the deck 52 adjacent the supports 54 for increased stability.

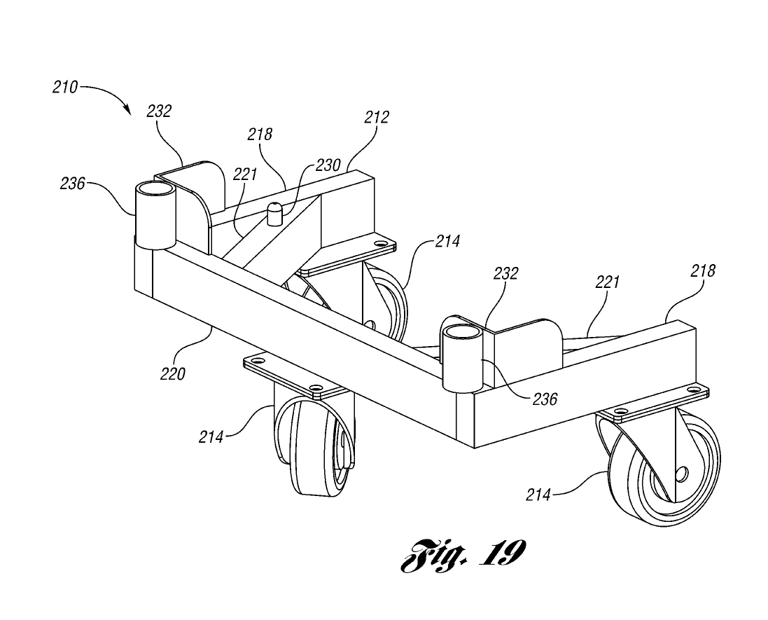

FIG. 19 is a perspective view of a dolly 210 according to a third embodiment. In the example shown, two such dollies 210 would be used in pairs, each at one end of the pallet, as in the previous embodiment. The dolly 210 includes a base 212 having casters 214 (in this example, three) supporting the base 212. The base 212 includes a pair of side walls 218 extending upward from the casters 214 and an end wall 220 extending upward from the casters 214 and connecting one end of each of the side walls 218. An angled support 221 extends at an angle across each corner of the dolly 210, connecting the side walls 218 and end wall 220. A post 230 extends upward from each angled support 221. The posts 230 are taller than the side walls 218, end wall 220 and angled support 221. A corner flange 232 extends upward from each corner formed by the side walls 218 with the end wall 220. Brackets 236, such as the cylindrical brackets shown, may be formed in the corners of the dolly 210, for optionally mounting a handle.

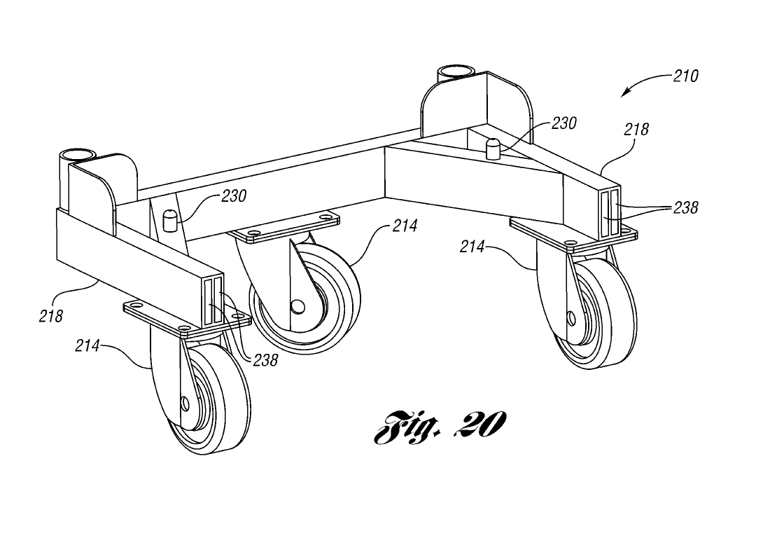

FIG. 20 is an inner perspective view of the dolly 210 of FIG. 19. As shown, the dolly 210 may include one or more optional magnets 238 at the inner end of one or both of the side walls 218. In the example shown, the magnets 238 are placed inside the side walls 218, but they could also extend from an exterior mount on the side walls 218 or from the plates of the casters 214.

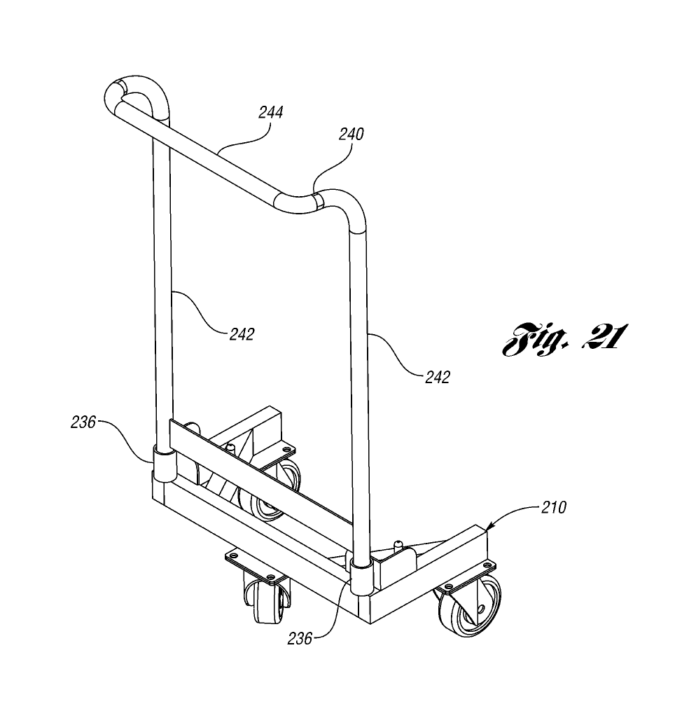

FIG. 21 shows the dolly 210 with an optional handle 240 mounted thereto. The handle 240 includes two vertical portions 242 leading to a handle portion 244. The vertical portions 242 are slidably received in the brackets 236 of the dolly 210. The handle 240 may be formed of metal tube, as shown, or from other suitable materials.

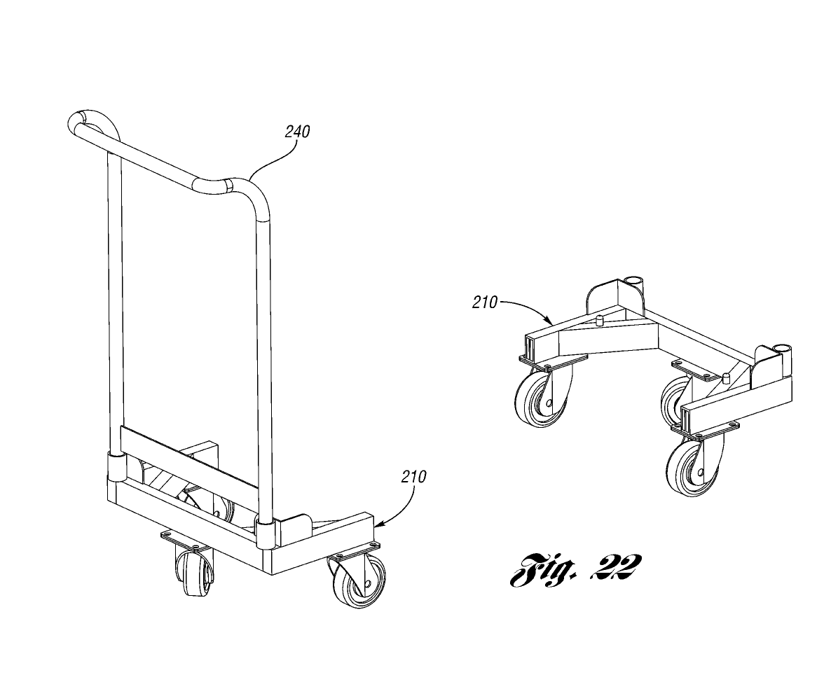

As shown in FIG. 22, a pair of dollies 210 are spaced apart with their inner ends facing one another, ready to receive a pallet thereon. One (or both) of the dollies 210 may be fitted with the handle 240.

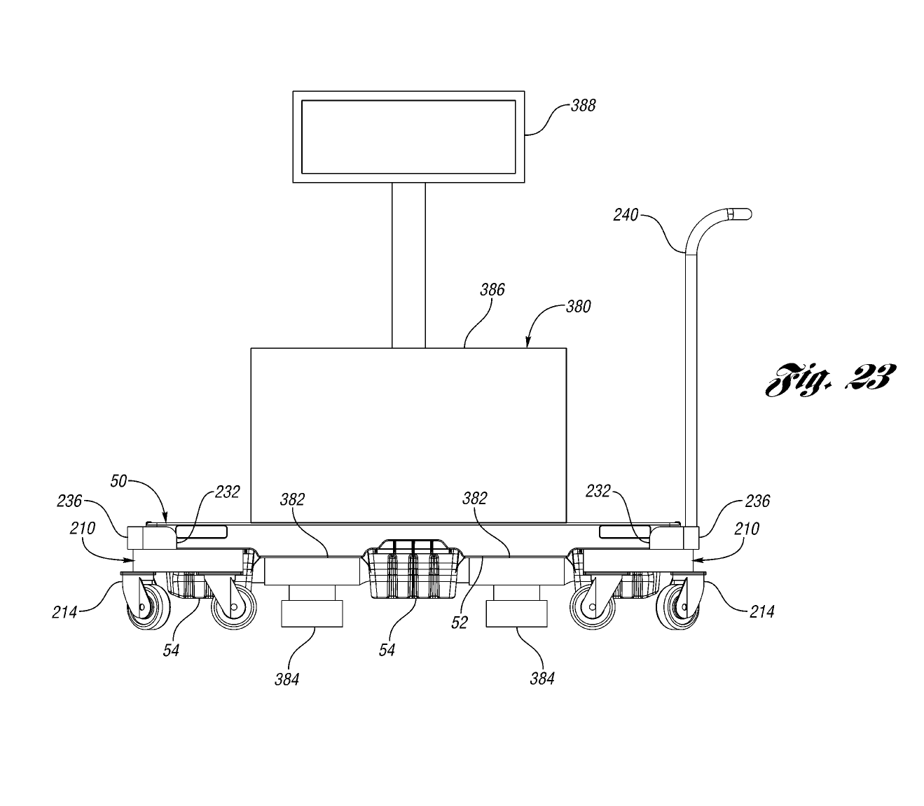

FIG. 23 shows the pallet 50 being transferred from a pallet lift jack 380 to the pair of dollies 210. The pallet lift jack 380 is well-known and is shown generally. The pallet lift jack 380 includes a pair of forks 382 for lifting the pallet 50. Wheels or rollers 384 support the forks 382 on the floor. A lift mechanism 386 can selectively raise and lower the forks 382 relative to the rollers 384 and the floor to lift and lower the pallet 50. A handle 388 permits a user to move and control the pallet lift jack 380. The deck 52 of the pallet 50 is supported on the forks 382.

To transfer the pallet 50 from the pallet lift jack 380 to the dollies 210, the magnets 238 in the inner ends of the side walls 218 can be positioned near or against the forks (contact is not required), such that the magnets 238 keep the dollies 210 in position until the pallet 50 is lowered onto the dollies 210. This makes the dollies 210 easier to use with one or two people, especially on uneven flooring. The deck 52 of the pallet 50 is then supported on the side walls 218 and end wall 220 of each dolly 210. The deck 52 is located between the corner flanges 232. The supports 54 extend downward below the upper surfaces of the side walls 218 and end walls 220. The dollies 210 only slightly increase the footprint of the pallet 50. As in the previous embodiment, the posts 230 (not shown) extend upward into the deck 52 adjacent the supports 54 for increased stability.

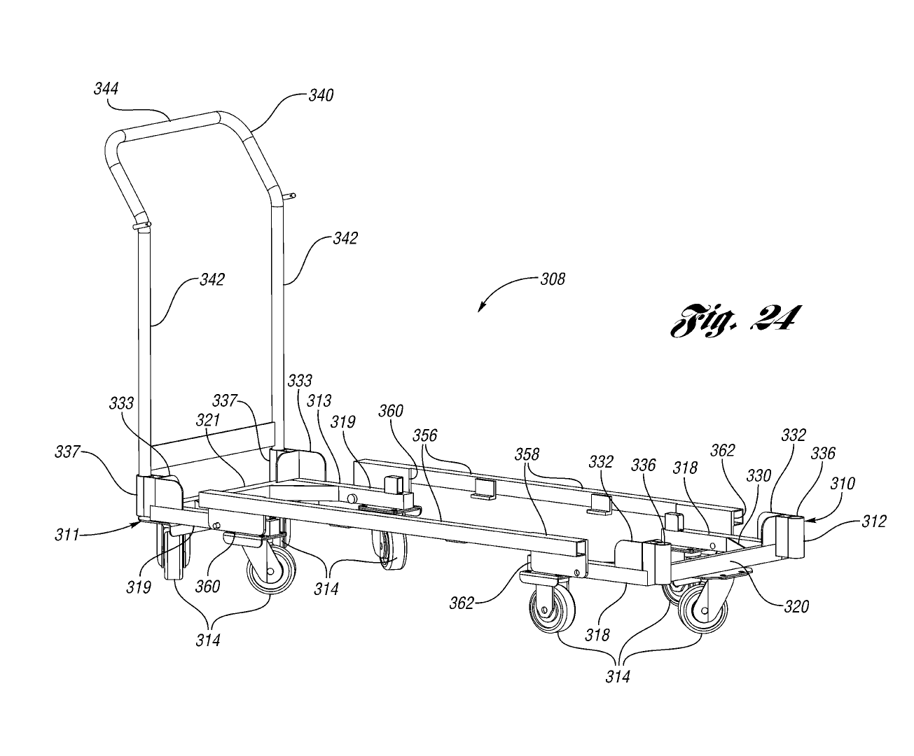

FIG. 24 is a perspective view of a dolly assembly 308 according to a third embodiment. The dolly assembly 308 includes two dollies 310, 311 generally similar to those described with respect to and shown in FIGS. 19-23, except as shown or described below. The dolly 310 includes a base 312 having casters 314 (in this example, three) supporting the base 312. The base 312 includes a pair of side walls 318 extending upward from the casters 314 and an end wall 320 extending upward from the casters 314 and connecting one end of each of the side walls 318. An angled support 330 extends at an angle across each corner of the dolly 310, connecting the side walls 318 and end wall 320. A corner flange 332 extends upward from each corner formed by the side walls 318 with the end wall 320. Brackets 336, such as the cylindrical brackets shown, may be formed in the corners of the dolly 310, for optionally mounting a handle.

The dolly 311 includes a base 313 having casters 314 (in this example, four) supporting the base 313. The base 313 includes a pair of side walls 319 extending upward from the casters 314 and an end wall 321 extending upward from the casters 314 and connecting one end of each of the side walls 319. An angled support 330 extends at an angle across each corner of the dolly 311, connecting the side walls 319 and end wall 321. A corner flange 333 extends upward from each corner formed by the side walls 319 with the end wall 321. Brackets 337, such as the cylindrical brackets shown, may be formed in the corners of the dolly 311, for receiving a handle 340.

The handle 340 includes two vertical portions 342 leading to a handle portion 344. The vertical portions 342 are slidably received in the brackets 337 of the dolly 311. The handle 340 may be formed of metal tube, as shown, or from other suitable materials.

Notably, in this embodiment, the dolly 311 also includes a pair of spreader bar assemblies 356 each including a spreader bar 358 having a plate 360 near one end that is pivotably connected to one of the side walls 319. Each spreader bar assembly 356 includes a latch plate 362 near an opposite end for selectively connecting to the side walls 318 of the dolly 310. FIG. 24 shows the dollies 310, 311 connected by the spreader bar assemblies 356 to form the single unit dolly assembly 308 for improved handling. It is easier to load a pallet (e.g. pallet 50 in FIG. 15) on the dolly assembly 308 than the independently movable dollies of the previous embodiment. The spreader bar assemblies 356 make the magnets of the previous embodiment unnecessary. The spreader bars 358 are significantly longer than the dolly 311 itself and the dolly 310, such that the distance separating the dollies 310, 311 when connected is approximately equal to the length of the dollies 310, 311 together, or approximately twice the length of the dolly 311 or dolly 310. Longer or shorter distances may be used depending on the pallet.

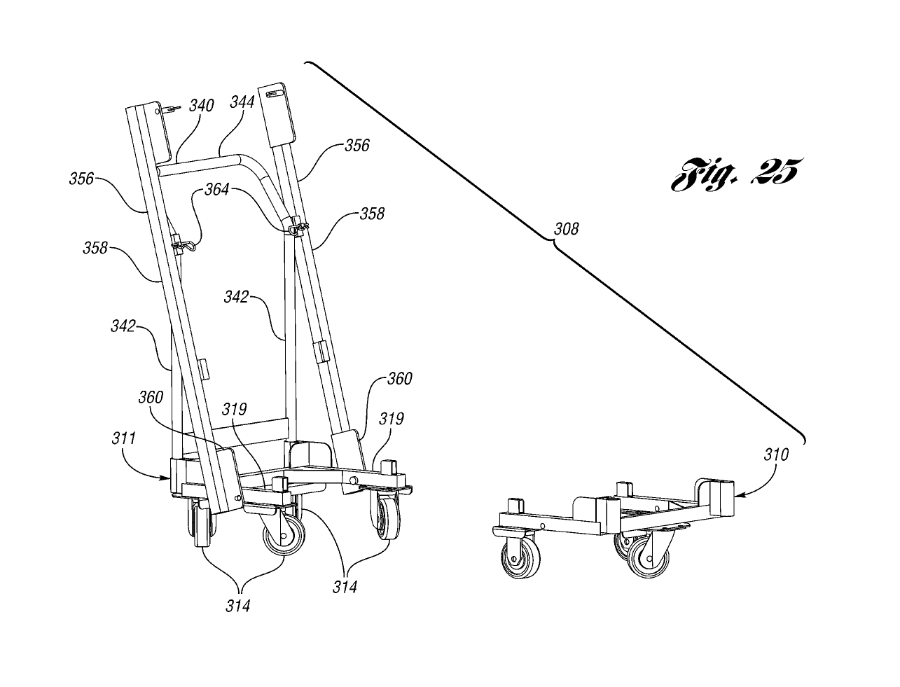

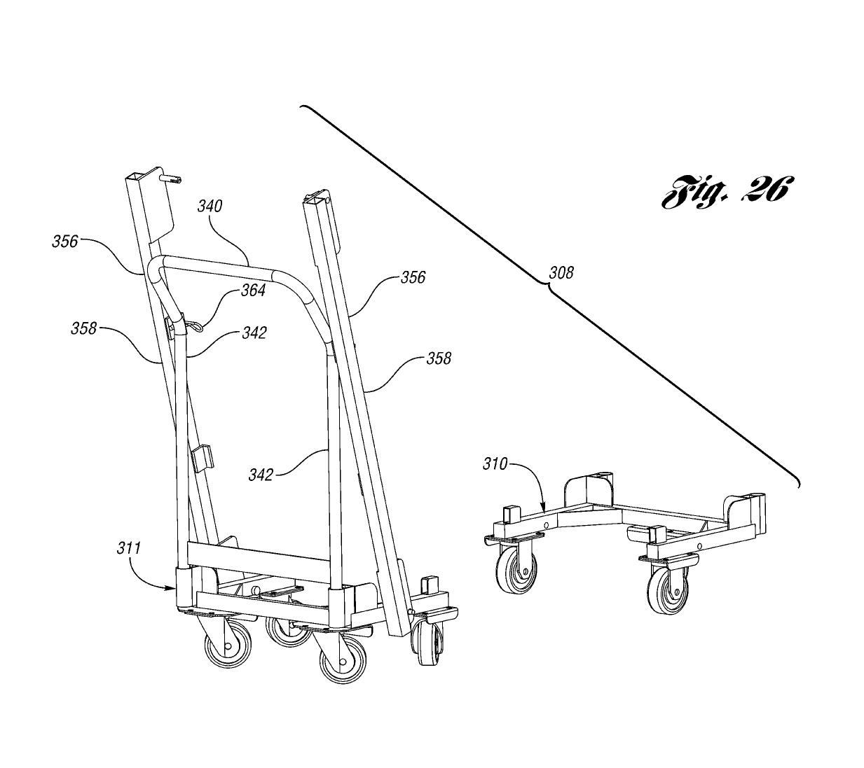

As shown in FIG. 25, the spreader bar assemblies 356 can be moved to a “stored” or “retracted” position. The spreader bar assemblies 356 are released from the dolly 310 and pivoted upward toward the handle 340. Retractable (or removable) pins 364 secure the spreader bars 358 to the vertical portions 342 of the handle 340. The height and weight of the spreader bar assemblies 356 in the stored position is one reason that four casters 314 may be desirable for dolly 311. FIG. 26 is a rear perspective view of the dolly assembly 308 of FIG. 25 in the disconnected, stored position.

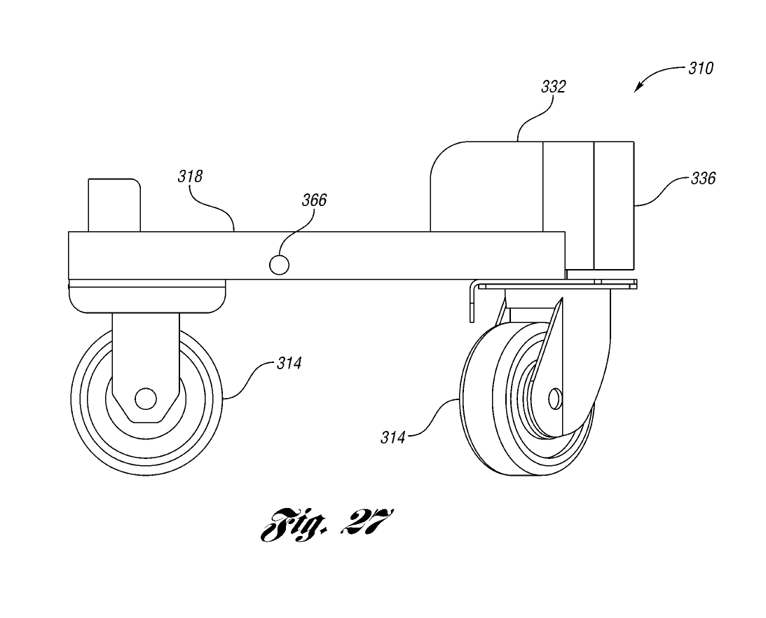

FIG. 27 is a side view of the dolly 310. As shown, the side wall 318 includes an aperture 366 therethrough (the opposite side wall 318 would also include such an aperture 366).

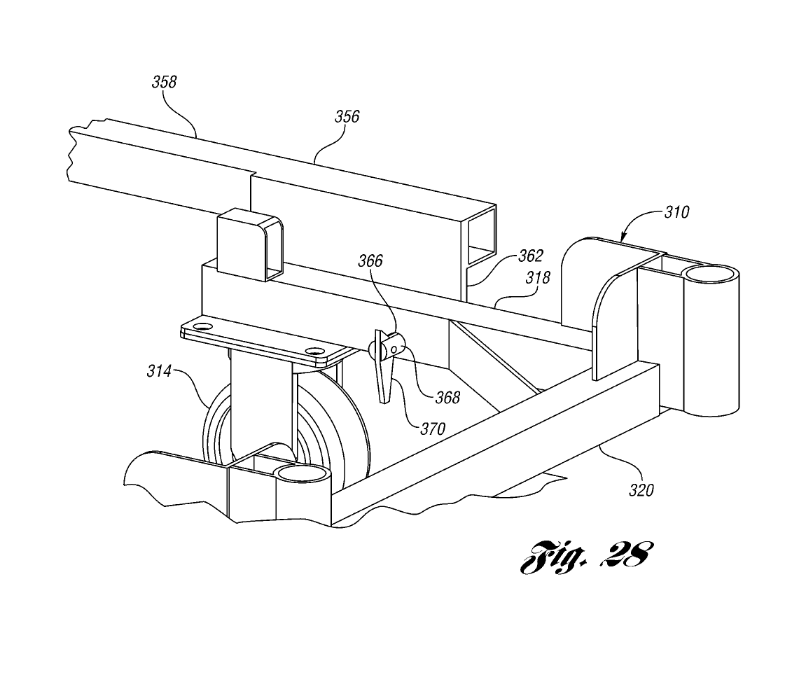

FIG. 28 is an enlarged interior perspective view of the dolly 310 of FIG. 1, as connected to one of the spreader bar assemblies 356. A connection pin 368 extends from the latch plate 362 through the aperture 366 in the side wall 318. A latch 370 is pivotably connected near an outer end of the connection pin 368. The latch 370 is pivotable from a released, unlocked position parallel to the connection pin 368 to a locked position generally transverse or perpendicular to the connection pin 368, as shown in FIG. 28. After the latch 370 and connection pin 368 are inserted through the aperture 366 of the side wall 318 (with the latch 370 in the released, parallel position), the latch 370 is pivoted to the locked position shown to securely connect the spreader bar assembly 356 to the dolly 310. The other spreader bar assembly 356 is connected to the other side wall 318 of the dolly 310 in a similar manner. Before storage, the spreader bar assemblies 356 can be disconnected from the dolly 310 by releasing the latches 370 and removing the connection pins 368 from the apertures 366 in the side walls 318.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A dolly comprising:
a base including a pair of spaced apart side walls and an end wall connecting the side walls; and
casters supporting the side walls and end wall.

2. The dolly of claim 1 further including a handle having a pair of vertical portions extending upward from the base to a handle portion.

3. The dolly of claim 1 further including at least one bracket projecting upward from the base.

4. The dolly of claim 1 further including at least one post projecting upward from the base.

5. The dolly of claim 1 further including at least one magnet at an end of one end of one of the side walls.

6. The dolly of claim 1 further including an angled support between each of the side walls and the end wall.

7. The dolly of claim 1 further including at least one spreader bar pivotably connected to one of the side walls.

8. The dolly of claim 7 wherein the spreader bar is significantly longer than the side walls.

9. In combination, where the dolly of claim 7 is a first dolly, the combination further including a second dolly having a base with a pair of spaced apart side walls, and end wall connecting the side walls and casters supporting the base, wherein the spreader bar is releasably connected to the second dolly.

10. The combination of claim 9 wherein a distance between the dolly and the second dolly is approximately twice a length of the dolly.

11. The combination of claim 10 further including a pallet having a deck and a plurality of supports extending downward from the deck, the supports spaced inward from peripheral edges of the deck, wherein the deck is supported on the bases of the first dolly and the second dolly.

12. In combination, a pallet and two dollies of claim 1, the dollies supporting opposite ends of the pallet, wherein the pallet includes a deck and a plurality of supports extending downward from the deck, the supports spaced inward from peripheral edges of the deck, wherein the deck is supported on the bases of the dollies.

13. The combination of claim 12 wherein the dollies are selectively and releasably connected to one another.

14. A dolly comprising:
a longitudinally-elongated base;
a divider extending longitudinally along at least a portion of the base; and
a plurality of casters supporting the base.

15. The dolly of claim 14 wherein the base includes a pair of spaced apart portions extending longitudinally.

16. The dolly of claim 15 wherein the divider includes at least one rail.

17. In combination, the dolly of claim 16 and a pallet, the pallet including a deck and a plurality of supports extending downward from the deck, the supports spaced inward from peripheral edges of the deck, wherein the plurality of supports are supported on the base of the dolly and wherein the divider is received between the plurality of supports.
